(19) United States
(12) Patent Application Publication
(10) Pub. No.: US 2019/0150437 A1
(43) Pub. Date: May 23, 2019

(54) USE OF SESQUITERPENES AND THEIR ANALOGS AS GREEN INSECTICIDES FOR CONTROLLING DISEASE VECTORS AND PLANT PESTS

(71) Applicant: Ohio State Innovation Foundation, Columbus, OH (US)

(72) Inventors: Peter M. PIERMARINI, Columbus, OH (US); Mark E. DREW, Columbus, OH (US); Harinantenaina L. RAKOTONDRAIBE, Columbus, OH (US)

(21) Appl. No.: 16/091,696

(22) PCT Filed: Apr. 6, 2017
(86) PCT No.: PCT/US17/26279

§ 371 Date: Oct. 5, 2018

Related U.S. Application Data
(60) Provisional application No. 62/318,987, filed on Apr. 6, 2016.

(51) Int. Cl. A01N 37/40; A01N 65/08; A01N 43/90; A01N 43/28; A01N 43/08; A01N 43/12

(52) U.S. Cl. CPC A01N 37/40; A01N 65/08; A01N 43/12; A01N 43/28; A01N 43/08; A01N 43/90

(57) ABSTRACT

Applicant's invention relates to a new class of ‘green’ insecticides for controlling agricultural, medical and veterinary pests. Applicants have identified and optimized natural compounds derived from Madagascan plants that exhibit insecticidal activity on important insect vectors (e.g., mosquitoes) and agricultural pests (e.g., soybean aphids). Plants of the genera Canellaceae, more specifically Cinnamosma, are shown herein to possess sesquiterpene compounds useful for compositions herein. The invention includes novel pesticide compositions, optimized components and methods of use.

### CROSS REFERENCE TO RELATED APPLICATION

This application claims priority under 35 U.S.C. § 119 to provisional application Ser. No. 62/318,987, filed Apr. 6, 2016, herein incorporated by reference in its entirety.

### FIELD OF THE INVENTION

The present invention relates to the field of naturally based, environmentally safe, and bio renewable insecticides.

### BACKGROUND OF THE INVENTION

The yellow fever mosquito Aedes aegypti is the most important global vector of dengue, yellow, chikungunya, and Zika fevers. The northern house mosquito Culex pipiens is an important vector of West Nile disease in the United States. The malaria mosquito Anopheles gambiae is a major vector of malaria in Africa. The soybean aphid Aphis glycines is an economically important pest of soybean crops in the U.S.

Traditional pesticides use compounds with broad-spectrum toxicity such as organophosphates, carbamates, organochlorines, and pyrethroids as active ingredients.

It is an object of the present invention to provide insecticides that are naturally based, environmentally safe, and bio-renewable as insecticides.

Yet another object of the invention is to provide insecticides that are nonharmful to humans if ingested.

Yet another object of the invention is to develop analogs of naturally derived compounds that are more efficacious.

Yet another object of the invention is to provide compositions that are effective as insecticides for traditional insecticide applications such as by spray and the like.

Other objects of the invention will be clear from the description of the invention which follows.

### SUMMARY OF THE INVENTION

Applicant's invention relates to a new class of ‘green’ insecticides for controlling agricultural, medical and veterinary pests. The compounds are natural products and are often ingested by humans for traditional medicine purposes. Thus, their toxicity against humans and vertebrates is expected to be low. In addition, the invention will provide other tools for combatting insect pests that have become resistant to conventional insecticides.

The invention is based on the novel use of natural compounds derived from Madagascan plants as ‘green’ insecticides. Many plants protect themselves from herbivorous insects by producing secondary compounds that either deter insects from eating them (e.g., a irritant) or poisoning them. Applicants have identified compounds from plants that exhibit insecticidal activity on important insect vectors (e.g., mosquitoes) and agricultural pests (e.g., soybean aphids).

According to the invention compounds that plants naturally use for defense against insects may be employed as environmentally safe, natural based insecticides. Native plants of Madagascar that are used in traditional medicine for treating a variety of maladies are employed and their extracted components have been shown to possess anti-malarial activity. Activity was also demonstrated against the yellow fever mosquito Aedes aegypti and the soybean aphid Aphis glycines.

Plants of the genera Canellaceae, more specifically Cinnamosma, are shown herein to possess sesquiterpene compounds useful for compositions herein. These compounds were isolated from Madagascan Canellaceae plant parts preferably the bark of the plant Cinnamosma fragrans. The plant is used in Madagascan traditional medicine as a ‘cure-all’, and in particular is used for treating rheumatism, muscular aches, and cough. The compounds identified for insecticidal activity were cinnamodial (CDIAL), cinnafragrin A (CM18), and cinnamosmolide (CMOS).

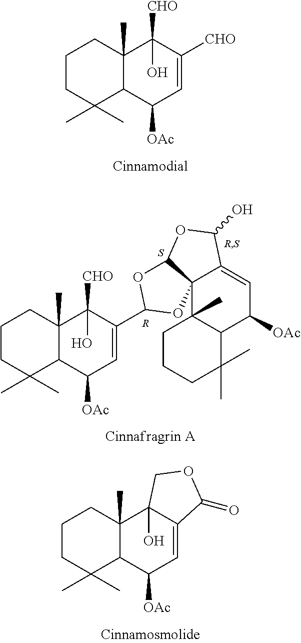

In another embodiment of the invention, the compounds above may be subjected to biotransformation to create and identify analogs that are more soluble or have increased toxicity. It is expected that these analogs will have more oxygen constituents and will have increased polarity that will demonstrate improved toxicity. Methods for such biotransformation protocols are known to those of skill in the art and are described in Liva Harinantenaina et al. Chem. Pharm Bull. Chem. Pharm. Bull. 53(2) 256-257 (2005).

Accordingly, the present invention provides an insecticide or an agent for exterminating or controlling insects (e.g., injurious insects) of high insect-repellency and insecticidal activity, and a process for producing the same.

Another embodiment of the present invention is to provide an insecticide or an insect-repellent agent which is highly safe to human beings, plants and animals and does not adversely affect the environment, and a process for producing the same.

Yet another embodiment of the invention is to provide a method for exterminating or controlling insects (e.g., injurious insects) assuredly and efficiently.

The inventors of the present invention have identified an insecticide or an insect-repellent agent which is derived from Madagascan plants that exhibits high insecticidal activity and repellency against insects, and found that components contained in specific plants, extracts thereof are highly safe, insecticidal and insect-repellent. According to the invention sesquiterpenoids from the plant species C. fragrans have been found as effective insecticides.

Thus, the insecticide or insect-repellent agent of the present invention comprises at least one member selected from a plant, an extract of the plant, a sesquiterpene compound or optimized derivative of the same and an insecticidal composition, each containing an insecticidal component.

The extract may be a substance extracted with at least one member selected from water and a hydrophilic solvent. The amount of the insecticidal component is 0.01 to 80% by weight relative to the insecticide in terms of the extract.

The present invention further includes a process for producing an insecticide or an insect-repellent agent which comprises subjecting a plant to at least one step selected from the group consisting of: (i) a treatment step comprising at least one step selected from the group consisting of shredding, drying and pulverizing; (ii) an extraction step using an extracting solvent; whereby obtaining at least one member selected from the group consisting of a treated plant, an extract of the plant, each containing an insecticidal component.

The present invention further includes a method for exterminating or controlling injurious insects using the above insecticide.

In the specification, the term “insecticidal” or “insect-repellent” is taken to mean both insecticidability and repellency against insects including injurious insects.

As will be described below, since the insecticide of the present invention comprises an insecticidal component or ingredient derived from a plant specified above, it is highly safe and capable of exterminating and repelling insects (e.g., injurious insects) without adversely affecting the ecosystem of nature.

### Definitions

In order to provide a clear and consistent understanding of the specification and the claims, including the scope given to such terms, the following definitions are provided. Units, prefixes, and symbols may be denoted in their SI accepted form. Unless otherwise indicated, nucleic acids are written left to right in 5′ to 3′ orientation; amino acid sequences are written left to right in amino to carboxy orientation, respectively. Numeric ranges are inclusive of the numbers defining the range and include each integer within the defined range. Amino acids may be referred to herein by either their commonly known three letter symbols or by the one-letter symbols recommended by the IUPAC-IUB Biochemical nomenclature Commission. Nucleotides, likewise, may be referred to by their commonly accepted single-letter codes. Unless otherwise provided for, software, electrical, and electronics terms as used herein are as defined in The New IEEE Standard Dictionary of Electrical and Electronics Terms (5th edition, 1993). The terms defined below are more fully defined by reference to the specification as a whole.

As used herein, the term “plant” can include reference to whole plants, plant parts or organs (e.g., leaves, stems, roots, etc.), plant cells, seeds and progeny of same. Plant cell, as used herein, further includes, without limitation, cells obtained from or found in: seeds, suspension cultures, embryos, meristematic regions, callus tissue, leaves, roots, shoots, gametophytes, sporophytes, pollen, and microspores. Plant cells can also be understood to include modified cells, such as protoplasts, obtained from the aforementioned tissues. The class of plants which can be used in the methods of the invention is generally as broad as the class of higher plants amenable to transformation techniques, including both monocotyledonous and dicotyledonous plants.

The terms “polypeptide”, “peptide” and “protein” are used interchangeably herein to refer to a polymer of amino acid residues. The terms apply to amino acid polymers in which one or more amino acid residue is an artificial chemical analogue of a corresponding naturally occurring amino acid, as well as to naturally occurring amino acid polymers. The essential nature of such analogues of naturally occurring amino acids is that, when incorporated into a protein that protein is specifically reactive to antibodies elicited to the same protein but consisting entirely of naturally occurring amino acids. The terms “polypeptide”, “peptide” and “protein” are also inclusive of modifications including, but not limited to, glycosylation, lipid attachment, sulfation, gamma-carboxylation of glutamic acid residues, hydroxylation and ADP-ribosylation. It will be appreciated, as is well known and as noted above, that polypeptides are not entirely linear. For instance, polypeptides may be branched as a result of ubiquitination, and they may be circular, with or without branching, generally as a result of posttranslation events, including natural processing event and events brought about by human manipulation which do not occur naturally. Circular, branched and branched circular polypeptides may be synthesized by non-translation natural process and by entirely synthetic methods, as well. Further, this invention contemplates the use of both the methionine-containing and the methionine-less amino terminal variants of the protein of the invention.

### DESCRIPTION OF THE FIGURES

FIG. 1 shows a map of the island of Madagascar indicating where these species are found.

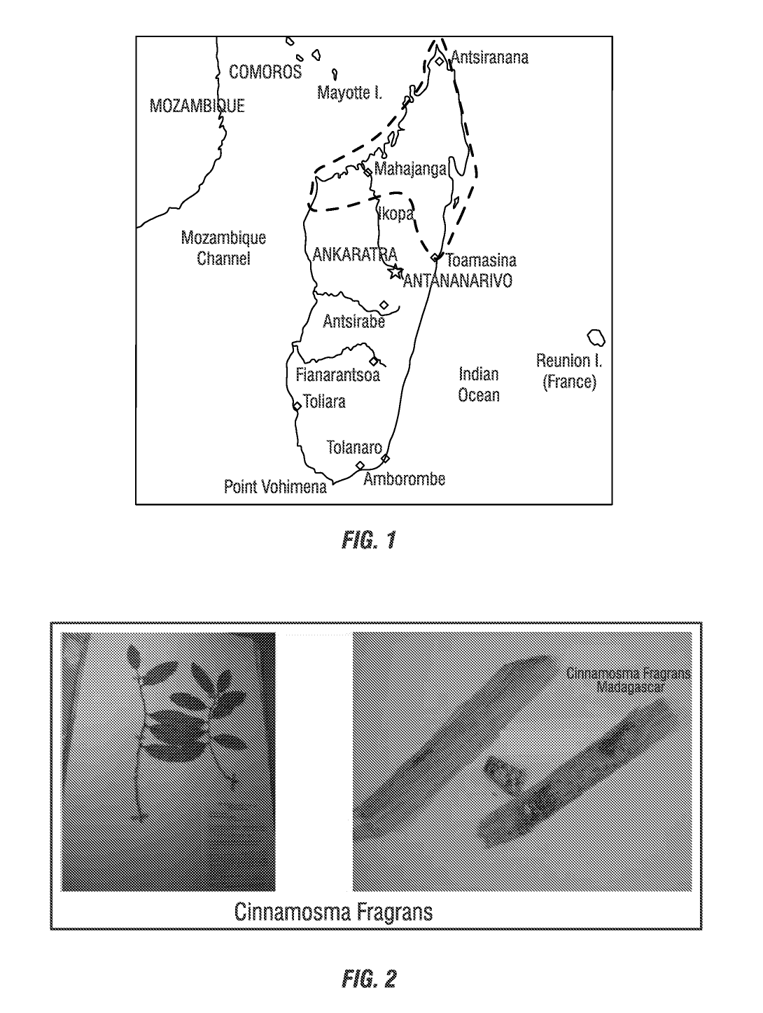

FIG. 2 shows photographs of the plant.

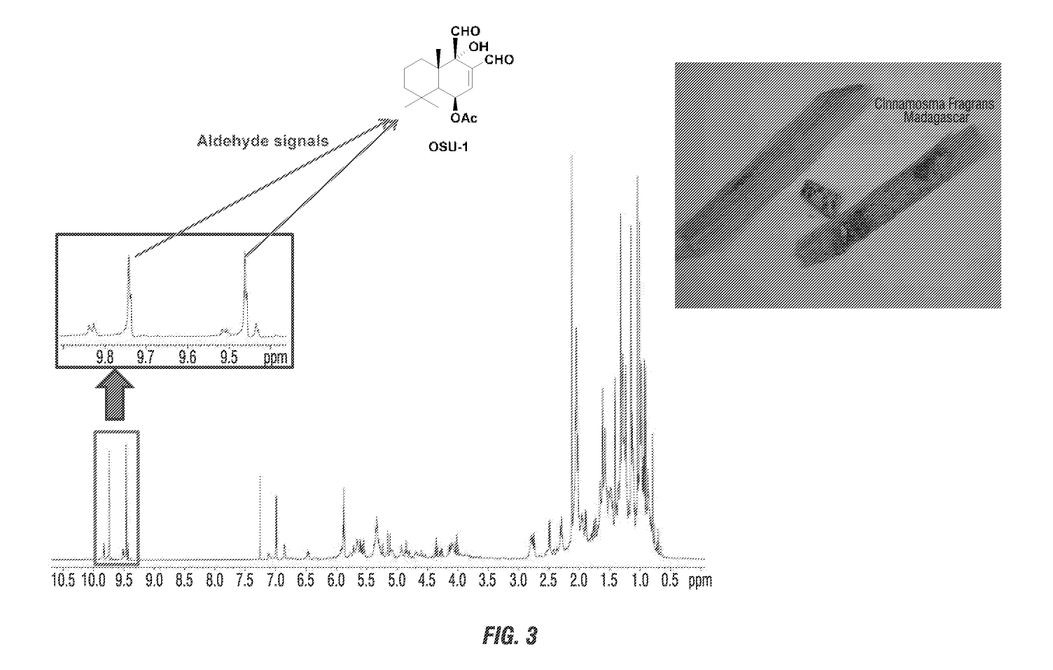

FIG. 3 shows the chromatogram and purification of OSU-1 (CDIAL).

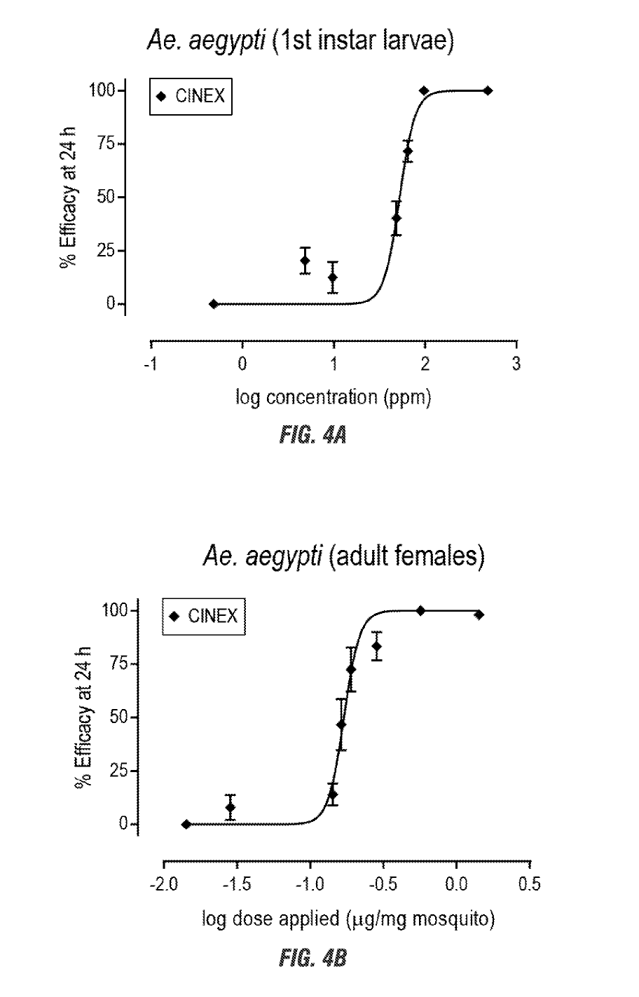

FIG. 4 shows the toxicity of the C. fragrans bark extract (CINEX) and compounds isolated from CINEX against Ae. aegypti. A,C) Concentration-toxicity relationships in 1st instar larvae 24 h after adding CINEX or indicated compound to the rearing water. B,D) Dose-toxicity relationships in adult females 24 h after applying CINEX or indicated compound to the thoracic cuticle. CDIAL=OSU-1.

FIG. 5 shows the comparative toxicity of CDIAL in larval (A) and adult female (B) mosquitoes (C. pipiens and An. gambiae) 24 h after adding to the rearing water or applying to the thoracic cuticle, respectively. The concentration/dose-toxicity relationships for Ae. aegypti from FIG. 4 are superimposed to facilitate comparisons.

FIG. 6 shows the toxicity of CINEX and compounds isolated from CINEX against the soybean aphid Aphis glycines. Dose-toxicity relationships in 3rd instar nymphs 24 h after adding CINEX or indicated compound to the thoracic cuticle. CDIAL=OSU-1.

FIG. 7 is an ORTEP drawing of CDIAL (X-ray structure) and its deduced chemical structure. The chemical structure of DEET is also shown for comparison.

FIG. 8 is a graph showing repellent efficacy of CINEX and CDIAL (OSU-1) compared to DEET, an industry standard. Values are means±SEM; N=31, 9, 5, and 15 respectively for Control, DEET, CINEX, and CDIAL. Lower-case letters indicate statistical categorization of the means as determined by a one-way ANOVA with a Newman-Keuls posttest (P<0.05).

### DETAILED DESCRIPTION OF THE INVENTION

The insecticide or insect-repellent agent of the present invention need only contain insecticidal or insect-repellent ingredients derived from a plant as specified above and may be a processed plant (no extraction) which is, if needed, shredded (or cut), dried, and pulverized (crushed, milled, ground, etc.). The above extract can be obtained according to a conventional method, for example, by processing or treating the plant in such a manner as explained above, then extracting the processed plant (or the treated plant) with a suitable solvent under atmospheric pressure or applied pressure and at room temperatures or on heating. Thereafter, the resultant extract is filtered and condensed, if needed. The plant can be subjected to extraction either singly or in combination.

The part (organ) of the plant to be subjected to extraction is different depending on the species and may be the whole or a part (organ), such as root, stem (stalk), leaf, fruit or acorn (nut), seed, rind (pericarp), cortex (bark), trunk, branch, and flower. In a preferred embodiment the plant part is bark.

As the extracting solvent, there may be exemplified water; alcohols such as methanol, ethanol, n-propanol, i-propanol, n-butanol, i-butanol, sec-butanol, t-butanol, n-octanol, and cyclohexanol; ethers such as ethyl ether, propyl ether, isopropyl ether, dimethoxyethane, cyclic ethers (e.g., dioxane, tetrahydrofuran), mono- or di-alkylene glycol monoalkylethers (e.g., ethylene glycol monomethylether, ethylene glycol monoethylether, diethylene glycol monoethylether); ketones such as acetone, methyl ethyl ketone, methyl isobutyl ketone, and cyclohexanone; esters such as ethyl acetate and butyl acetate; halogenated hydrocarbons such as carbon tetrachloride, chloroform, dichloromethane and 1,2-dichloroethane; aliphatic hydrocarbons such as hexane and octane; alicyclic hydrocarbons such as cyclohexane and cycloheptane; aromatic hydrocarbons such as benzene, toluene and xylene; nitrites such as acetonitrile; carboxylic acids such as formic acid and acetic acid; and aprotic polar solvents such as N,N-dimethylformamide, dimethyl sulfoxide, and pyridine. These solvents can be used either singly or in combination.

Of these solvents, preferred extracting solvents include water, hydrophilic solvents, and mixtures thereof. The preferred hydrophilic solvents include, e.g., straight- or branched chain alcohols having about 1 to 4 carbon atoms; ethers such as dimethoxyethane, cyclic ethers, mono- or di-alkylene glycol monoalkylethers; ketones such as acetone; nitriles; organic carboxylic acids; and aprotic solvents.

Particularly preferred solvents include water; water-soluble (or water-miscible) solvents such as straight- or branched alcohols having 1 to 4 carbon atoms, and acetone; and mixtures thereof.

The amount of the extracting solvent need only be in the range not adversely affecting the extractability or extracting operations. For example, the amount of the solvent is about 50 to 10,000 parts by weight, preferably about 70 to 5,000 parts by weight, and more preferably about 100 to 2,000 parts by weight, relative to 100 parts by weight of the plant to be extracted from. The extraction temperature is, e.g., about 0 to 150° C. and preferably in the range of from room temperatures (e.g., 25° C.) to about 120° C.

In the present invention, a plurality of plants, extracts, or exudates, of different genera may be mixed together. Moreover, a combination of two or more members selected from the group consisting of a processed plant, or extract, may also be used. The extract may be in liquid form, or in solid form as a powder or particulates, or in semi-solid form as a paste. The processed plant, extract, or extracted components, contain insecticidal or insect-repellent components highly effective against insects (e.g., injurious insects). In addition to that, these insecticidal or insect-repellent components are natural ones and derived from edible plants or plants for crude drug, being usually safe to human beings and animals and less harmful to the environment.

In the insecticide or insect-repellent agent of the present invention, there is no specific limitation in its form so far as it contains the above ingredient or component, and it may be the plant processed or its extract itself. Moreover, the insecticide or insect-repellent agent may be in the form of a preparation. Examples of the form of the preparation include liquids such as solution, water-containing agent, dispersion, suspension, emulsion, oil, and lotion; solids such as powder, granules, microcapsules, microspheres, flowable agent, and foaming agent; semi-solids such as pastes and creams; atomizing agent, aerosol; and coating composition. These can suitably be selected according to the intended use and where to be applied to. These preparations can be produced in accordance with conventional processes. The above liquid or semi-solid preparation can be produced by, for example, diluting the above extract with a suitable liquid diluent or a carrier. In the case of a water-containing agent, a solid diluent or carrier may be further incorporated thereto.

As the liquid diluent or carrier, there may be exemplified, in addition to the extracting solvents exemplified above, alcohols such as ethylene glycol, propylene glycol, and glycerol; plasticizers (e.g., ester-series plasticizers such as di-2-ethylhexyl adipate); petroleum-series solvent such as kerosene; aromatic hydrocarbons such as ethylnaphthalene and phenylxylylethane; and phosphates such as 2-ethylhexyl phenyl phosphate. The liquid diluent or carrier can be used either singly or in combination. As the solid diluent or carrier, use can be made of diatomaceous earth, mica, clay, kaolin, talc, powdered quartz, bentonite, and the like. These solid diluents or carriers are also can be used either singly or as a mixture thereof.

The solid preparation can be produced by, for example, diluting or granulating (or pelletizing) the extract with a suitable solid diluent or carrier. As the solid diluent or carrier, there may be exemplified, besides the solid diluents exemplified above, talc such as powdered talc and powdered agalmatolite, clay such as finely powdered clay, mineral powders such as calcium carbonate, etc.; sulfur powder; urea powder; vegetable powders such as wood flour and starch; and various carriers frequently used for agrochemical compositions and horticultural preparations, etc. These solid diluents or carriers are often used as extenders and can be used either singly or in combination.

The aerosol can be produced by diluting the extract with a suitable solvent if needed and charging a container or vessel with the diluted extract together with a propellant. As the solvent, there may be mentioned those exemplified above. As the propellant, there may be mentioned, for example, flon and liquefied natural gas.

If needed, to the insect-repellent agent or insecticide may be added various additives according to the type of the preparation. Examples of the additive are antiseptic/antimold agents; stabilizers such as antioxidants and ultraviolet ray absorbents; binders; film-formable resins; emulsifying agents, dispersants, spreading agents, wetting agents; penetrants; thickeners; auxiliary fluidizing agents; consolidation inhibiting agents; flocculating agents; ultraviolet ray scattering agents; dehydrating agents, and colorants.

As an example of the above antiseptic/antimold agent, there may be exemplified iodine-containing organic compounds such as 3-bromo-2,3-diiodo-2-propenyl ethyl carbonate, 3-iodo-2-propynyl butyl carbamate, 2,3,3-triiodo allyl alcohol, and parachlorophenyl-3-iodopropar-gylformal; benzimidazole compounds and benzthiazole compounds such as 2-(4-thiazolyl)benzimidazole and 2-thiocyanomethylthiobenzo-thiazole; triazole compounds such as 1-(2-(2′,4′-dichlorophenyl)-1,3-dioxolane-2-yl-methyl)-1H-1,2,4-triazole, 1-(2-(2′,4′-dichlorophenyl)-4-propyl-1,3-dioxol-ane-2-ylmethyl)-1H-1,2,4-triazole, and .alpha.-(2-(4-chlorophenyl)ethyl)-.-alpha.-(1,1-dimethylethyl)-1H-1,2,4-triazole-1-ethanol; and naturally occurring compounds such as 4-isopropyltropolone(hinokitiol) and borax.

As an antioxidant, there may be exemplified phenolic antioxidants such as 4,4′-thiobis-6-t-butyl-3-methylphenol, butylated hydroxyanisole (a mixture of 2-t-butyl-4-methoxyphenol and 3-t-butyl-4-methoxyphenol), p-octylphenol, mono (or di- or tri-)-(.alpha.-methylbenzyl)phenol, 2,6-di-t-butyl-p-cresol (BHT), and pentaerythrityl tetrakis[3-(3,5,-di-t-butyl-4-hydroxyphenyl)]propionate; amine antioxidants such as N,N′-di-2-naphthyl-p-phenylenediamine; hydroquinoline antioxidants such as 2,5-di(t-amyl)hydroquinoline; sulfur-containing antioxidants such as dilauryl thiodipropionate; and phosphorus-containing antioxidants such as triphenyl phosphite.

As a ultraviolet ray absorbent, there may be mentioned, for example, benzotriazole compounds such as 2-(2′-hydroxy-5′-methylphenyl)benzotriazole and 2-(2′-hydroxy-4′-n-octoxyphenyl)benzotriazole; benzophenone compounds such as 2-hydroxy-4-methoxybenzophenone and 2-hydroxy-4-n-octoxybenzophenone; salicylic acid compounds such as phenyl salicylate and p-t-butylphenyl salicylate; 2-ethylhexyl 2-cyano-3,3-diphenyl acrylate, 2-ethoxy-2′-ethyl oxalic bisanilide, and dimethyl succinate-1-(2-hydroxyethyl)-4-hydroxy-2,2,6,6-tetramethylpiperidine polycondensate.

As a binder, there may be exemplified a sodium salt of carboxymethylcellulose, methyl cellulose, ethyl cellulose, hydroxymethyl cellulose, dextrin, .alpha.-starch, polyvinyl alcohol, polyvinylpyrrolidone, sodium ligninsulfonate, and potassium ligninsulfonate.

Examples of the film-formable resin are thermoplastic resins (e.g., polyolefinic resins such as polyethylene and polypropylene, polyvinyl acetate, polyvinyl alcohol, acrylic resins, polyvinyl chloride, styrenic resins, fluororesins, chlorinated polyolefins, alkyd resins, polyamide, and polyester); and thermosetting resins such as phenolic resins, urea resins, melamine resins, furan resins, unsaturated polyester resins, and epoxy resins.

As an emulsifying agent, a dispersant, a spreading agent, a wetting agent, or a penetrant, conventional surfactants such as anionic surfactants and nonionic surfactants can be employed. Examples of the anionic surfactant are metallic soaps, salts of sulfuric esters such as sodium alkylsulfate, alkylbenzene sulfonates such as sodium alkylbenzene sulfonate, alkylnaphthalenesulfonates such as sodium alkylnaphthalene sulfonate [e.g., NewCalgen BX-C (tradename), manufactured by Takemoto Yushi, K.K.), salts of dialkyl 2-sulfosuccinates such as sodium dialkyl 2-sulfosuccinate [e.g., Neocol SW-C (tradename), manufactured by Dai-ichi Kogyo Seiyaku Co., Ltd.], polycarboxylic acid-based surfactants [e.g., Toxanon GR-30 (tradename), manufactured by Sanyo Kasei Co., Ltd.], .alpha.-olefin sulfonates, polyoxyethylenedistyrenephenylether sulfate ammonium salt [e.g., Dixzol 60A (tradename), manufactured by Dai-ichi Kogyo Seiyaku Co., Ltd.], sodium ligninsulfonate, and potassium ligninsulfonate. Examples of the nonionic surfactant are polyoxyethylene alkyl ethers and polyoxyethylenealkylarylether [e.g., Noigen EA-142 (tradename), manufactured by Dai-ichi Kogyo Seivaku Co., Ltd. (EA-142)], polyoxyethylenearylether, esters of fatty acids with polyhydric alcohols, fatty acid polyhydric alcohol polyoxyethylenes, fatty acid esters of sucrose, block copolymers of ethylene oxide and propylene oxide [e.g., Newpol PE-64 (tradename), manufactured by Sanyo Kasei Co., Ltd.]. As a thickener, there may be mentioned, e.g., polyvinyl alcohol, polyacrylic acid and salts thereof. Examples of an auxiliary fluidizing agent are organic lubricants such as PAP subsidiary agents (e.g., isopropylphosphoric acid), wax, polyethylene, metal salts of fatty acids, paraffin, and silicone oils, and inorganic lubricants such as talc. As a consolidation inhibitor (or an anti-blocking agent), there may be mentioned, for example, white carbon, diatomaceous earth, magnesium stearate, aluminum oxide, and titanium dioxide. Examples of flocculating agents are liquid paraffin, ethylene glycol, diethylene glycol, triethylene glycol, and isobutylene polymers [e.g., produced by Idemitsu Petroleum Chemicals Co., Ltd., IP solvent-2835 (tradename)]. As the ultraviolet ray scattering agent, use can be made of, for example, titanium dioxide. Examples of a dehydrating agent are drying agents such as anhydrous gypsum and silica gel powder. Examples of a colorant include organic and inorganic pigments and dyes.

The insecticide or insect-repellent agent of the present invention may contain other insecticide or insect-repellent agent, or an effect enhancing agent. Other insecticides include organophosphorus insecticides such as Phoxim, Chlorpyrifos, fenitrothion, pyridaphenthion, isofenphos; carbamate-series compounds such as Bassa and Propoxur; pyrethroid insecticides such as Cyfluthrin, Permethrin, Tralomethrin, phenvalerate, Ethofenprox, and Hoe-498; neonicotinoid insecticides such as imidacloprid, nitenepyram, and acetamiprid, phenylpyrazole insecticides such as fipronil, nereistoxin compounds such as bensultap, hiba oil, hiba neutral oil, fatty acids such as decanoic acid and octanoic acid, boric acids, and plants such as the neem tree [Japanese Patent Application Laid-Open No. 41011/1991 (JP-A-3-41011)], and those belong to the genus Moringa and the genus Marah [Japanese Patent Application Laid-open No. 329514/1994 (JP-A-6-329514). Moreover, the insecticide of the present invention may contain a chitin synthesis inhibiting agent or inhibitor such as lufenuron, hexaflumuron, diflubenzuron and flufenoxuron or a juvenile hormone analogues such as methoprene and hydroprene, known as an insect growth regulator (IGR).

The content of the insecticidal or insect-repellent component can suitably be selected according to the form of the preparation or its application manner and is usually 0.01 to 80% by weight. When the preparation is in liquid form, or semi-solid or solid form, the concentration of the ingredient contained in the insecticide in terms of the extract or exudate of the plant is, for example, about 0.1 to 80% by weight and preferably about 0.5 to 50% by weight. When the agent is in aerosol form, the concentration of the ingredient in the charge filling a container is, in terms of the extract or exudate of the plant, for example about 0.01 to 25% by weight and preferably about 0.05 to 15% by weight.

The insecticide or insect-repellent agent of the present invention is applicable to various insects [e.g., injurious insects such as hygienically injurious ones (e.g., cockroaches, flies, mosquitoes, horseflies, bedbugs) and insects injurious to timber (e.g., termites, for example, (I) insects which belong to Isoptera, for example, those belonging to Rhinotemitidae such as Reticulitormes speratus and Coptotermes formosanus, and those belonging to Kalotermitidae such as Cryptotermes domesticus, and (2) insects which belongs to Coleoptera, for example, those belonging to Lyctidae such as Lyctus brunneus, Lyctus linearis, Lyctus sineusis, and Lyctoxylon dentatum). Even with a small dose of the insecticide or insect-repellent agent of the present invention exhibits efficient insecticidal activity when used to exterminate or control insects (e.g., insects injurious to houses such as termites). The insecticide of the present invention is effective especially to termites. Any one of the insecticidal or insect-repellent components or ingredients derived from the plants of the above-mentioned genera (1) to (14) is capable of exterminating or controlling termites effectively. Insecticidal or insect-repellent components or ingredients derived from the plants of the species (1a) to (14a) are effective and useful for exterminating or controlling termites. Such effects can be obtained even when a plant body itself is employed.

In the method of the present invention for exterminating and controlling insects (for example, injurious insects), the above insecticide is directly applied to insects, or indirectly acts on insects by being applied to spots or pathways along which insects come in or where they infest (or breed, or swarm), for example, kitchen, bath room, living room, the corners of the floor, under the floor, in the ceiling, the foundation of a house, pillars, walls, and the ground. The insecticide is applied in a manner suitable for an invasion or infestation spot (or invasion pathway, etc.) of insects (e.g., injurious insects), and various ways of application can be mentioned, such as coating, distributing, dipping or impregnating, injecting, mixing, and atomizing. When applying the insecticide to the soil or ground, the insecticide is distributed over the surface of the ground or along the grooves formed in the ground, or mixed with the soil. Further, the insecticide can exhibit its insect-repellent or insecticidal activity even when disposed on or applied to the above-mentioned invasion or breeding spots in the form of a sheet-type agent formed by allowing a sheet-like base material (substrate) such as a synthetic resin sheet, paper, or fabrics to support the insecticide by means of coating, impregnation, or kneading.

In the method of the present invention, the above-described insect-repellent or insecticidal ingredient exterminates or repels insects such as injurious insects (particularly, termites) efficiently and thus remarkably reduces the damage caused by such insects. Moreover, the application of the insecticide of the present invention to timber enables the preservation of timber without damage by insects such as termites.

The present insecticide can be applied to timber by various ways such as coating, dipping, impregnating, submerging, and injecting

The insecticide of the present invention exhibits excellent insecticidal or insect-controlling effect against insects (e.g., injurious insects). Moreover, since the insect-repellent and insecticidal ingredient or component is derived from a natural plant, the insecticide of the present invention is highly safe to human beings and animals and less harmful to the environment.

According to the production process of the present invention, such an excellent insecticide having characteristics as described above can be obtained with such a simple and easy operation as extraction or exudation.

According to the method of the present invention for exterminating and controlling insects (e.g., injurious insects), and insects (e.g., injurious insects) are repelled or exterminated with efficiency and safety.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims. Thus, many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims.

### Example 1

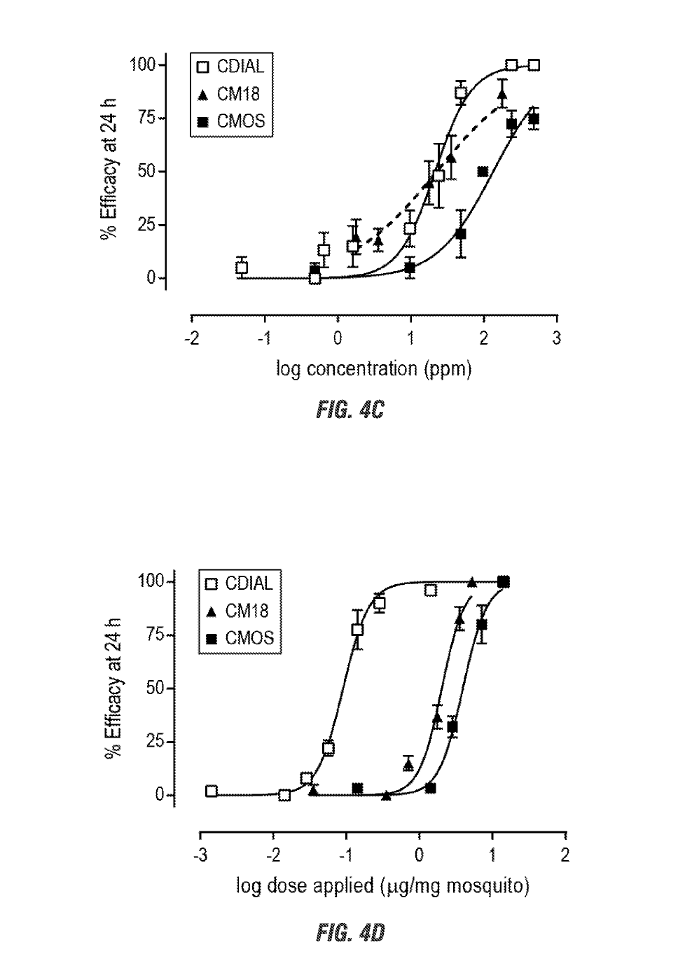

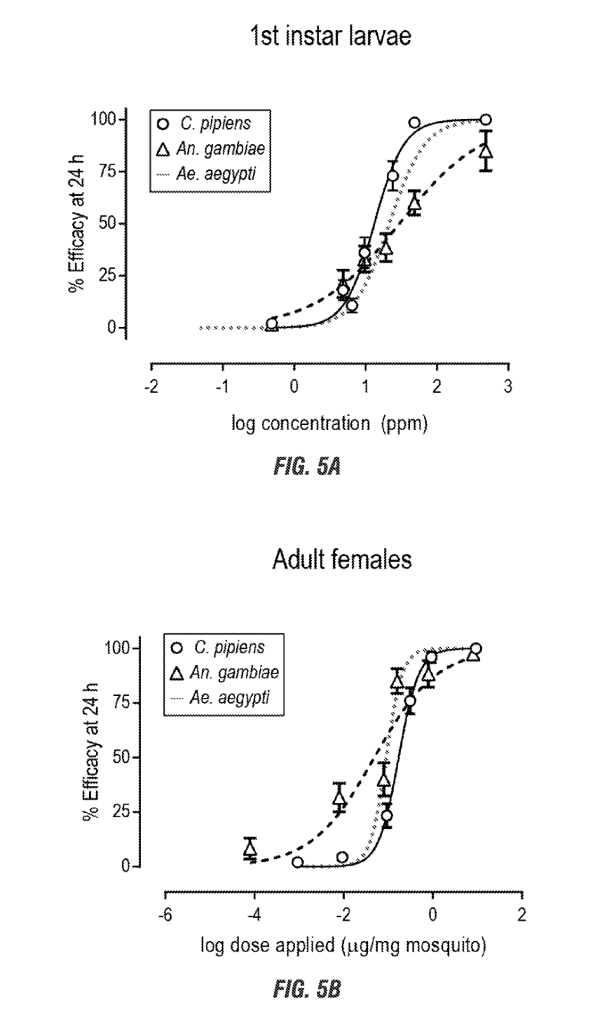

Each compound of cinnamodial (CDIAL), cinnafragrin A (CM18) and cinnamosmolide (CMOS) were isolated form the barks of the Madagascan plants Cinnamosma fragrans, Cinnamosma macrocarpa and Cinnamosma madagascariensis. Each was dissolved in 100% acetone and applied directly to the cuticle of adult female mosquitoes (Aedes aegypti, Anopheles gambiae, and Culex pipiens) or 3rd instar nymph soybean aphids (Aphis glycines). The bark extract and the isolated compounds was toxic to larval and adult female mosquitoes within 24 hr in a concentration/dose dependent manner (FIGS. 4 and 5). Among the isolated compounds. CDIAL was the most potent and efficacious (Table 1).

TABLE 1
Concentration-toxicity parameters of compounds isolated from CINEX on larval and adult
female mosquitoes. Asterisks indicate significant difference from CDIAL Daggers indicate
significant difference from A. aegypti.

| | Larval mosquitoes | | | Adult female mosquitoes | | |
|---|---|---|---|---|---|---|
| | EC₅₀ in ppm | | | ED₅₀ in μg/mg mosquito | | |
| | (95% CI) | | | (95% CI) | | |
| | A. aegypti | C. pipiens | A. gambiae | A. aegypti | C. pipiens | A. gambiae |
| CDIAL | 21.6 | 13.3† | 29.8 | 0.09 | 0.17† | 0.05† |
| | (16.6-28.05) | (11.5-15.4) | (20.75-42.8) | (0.08-0.105) | (0.15-0.20) | (0.03-0.09) |
| CM18 | 22.6 | N.D. | N.D. | 2.03* | N.D. | N.D. |
| | (12.9-39.6) | | | (1.80-2.295) | | |
| CMOS | 134.4* | N.D. | N.D. | 3.94* | N.D. | N.D. |
| | (93.4-193.4) | | | (3.45-4.50) | | |

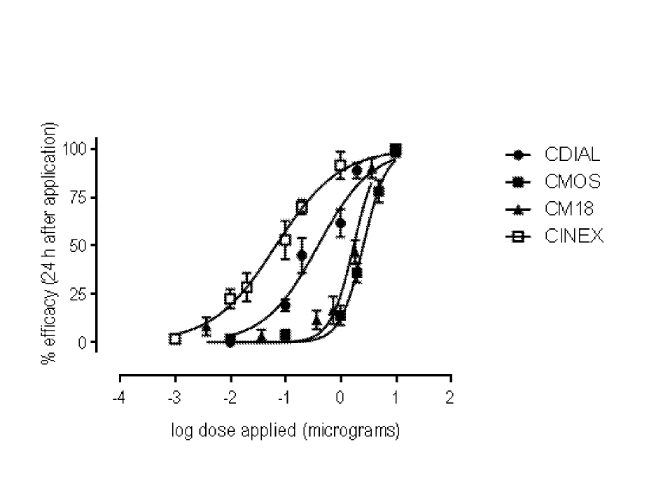

In aphids, CINEX and the isolated compounds also elicited dose-dependent toxicity within 24 h of application (FIG. 6). CDIAL was the most potent with an ED₅₀ of 0.38 μg/aphid, followed by CM18 and CMOS with ED₅₀ values of 1.7 μg/aphid and 2.5 μg/aphid, respectively. The data indicate that all 3 inhibitors are able to penetrate mosquito and aphid cuticles and that all have potential for use in a practical application, such as an insecticidal spray.

### Example 2

### Derivatives of CDIAL Developed by Inventors.

We have recently developed and synthesized at least six OSU-1 cinnamodial (CDIAL) derivatives and related compounds as well as development and synthesis of additional OSU-1 derivatives for screening in adult and larval Ae. aegypti.

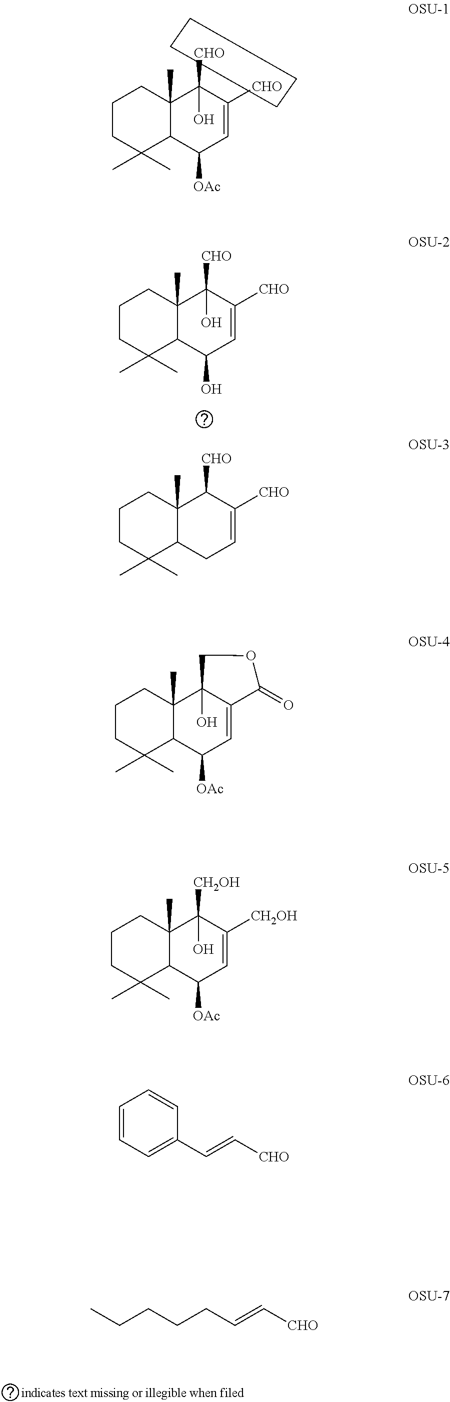

### Example 3

Methods for Extraction and Identification of Sesquiterpenes from Cinnamosma madagascariensis

The following excerpt details methods of extraction and the sesquiterpenes that have been identified from Cinnamosma madagascariensis.

Two new drimane-type sesquiterpenes, cinnamadin (1) and cinnamodial 11R,12-dimethyl acetal (2), together with pereniporin B (3), ugandensolide (4), polygodial (5), cinnafragrin A, cinnamodial (6), sitosterol, stigmasterol, lignoceric acid, cinnamosmolide (7), D-mannitol, and -tocotrienol were isolated from Cinnamosma madagascariensis. The structures of the new compounds were determined by physical, chemical, and spectroscopic evidence. Compound 7 and D-mannitol were isolated in high yield (5% and 1.36%, respectively). Evaluation of the Alpha-glucosidase inhibitory properties of the isolated metabolites demonstrated that compounds 1 and 4 show moderate effects, while cinnamodial (6) exhibited the most potent activity. The chemosystematics of Cinnamosma species are also discussed.

Our interest in the phytochemical investigation of Cinnamosma, the Malagasy endemic genus belonging to the Canellaceae family, has been initiated by the isolation of drimane-type sesquiterpene mono-, di-, and trimers from C. fragrans and C. macrocarpa.^{1,2} Cinnamosma fragrans is distributed in northern, central, and centraleastern parts of Madagascar, while C. macrocarpa and C. madagascariensis are found widely in the southeastern and in the southern part of this island. Although all three species are used in the Malagasy Pharmacopoea for many ailments, the prescriptions therein depend on the regions where they grow.¹ Cinnamosma madagascariensis has a more bitter taste compared to the other two species, which possess pungent tastes. The former is used in the southern part of the country mainly to treat cough and to strengthen the immune system.¹ Capsicodendrin and cinnamodial are the major biologically active constituents of C. fragrans and C. macrocarpa.^{2,3}

Since the isolation of a quaternary aporphine alkaloid (chakranine),⁴ and of N_{b}-p-coumaroyl- and N_{b}-feruloyltryptamine, (( )lyoniresinol, and 5-methoxy-9-xylopyranosyl-(−)-isolariciresinol from C. madagascariensis,⁵ the taxonomic placement of the family Canellaceae in the order Magnoliiflorae has been confirmed. With the aim of isolating new active compounds from Cinnamosma species, we have carried out a phytochemical investigation of C. madagascariensis Danguy collected in Sakaraha, Madagascar. This report deals with the isolation and structural determination of metabolites of C. madagascariensis, the Alpha-glucosidase inhibitory properties of the isolated metabolites, as well as a short discussion of the chemosystematics of the genus Cinnamosma.

The EtOAc-soluble fraction of C. madagascariensis bark was chromatographed repeatedly on silica gel, Sephadex LH-20, and ODS RP-18 columns to afford two new sesquiterpene drimanes (1 and 2), together with 10 known compounds identified as pereniporin B (3),⁶ ugandensolide (4),⁷ polygodial (5),⁸ cinnafragrin A,² cinnamodial (6),² sitosterol, stigmasterol, lignoceric acid, cinnamosmolide (7),⁷ and 6-tocotrienol.^{2,3} The structures of the known compounds were identified through the interpretation of their physical and spectroscopical data and by comparison with values reported in the literature.

Positive HRESIMS analysis of cinnamadin (1) exhibited a quasimolecular ion peak at m/z 331.1511 [M+Na]⁺, corresponding to the molecular formula C₁₇H₂₄O₅. The IR spectrum suggested the presence of a hydroxy, an R,-unsaturated γ-lactone carbonyl, and an O-acetyl group (νₘₐₓ 3420, 1675 and 1239, and 1730 cm⁻¹, respectively). The ¹H NMR spectrum (Table 2) displayed signals for three quaternary methyl protons (δ 1.41, 0.99, and 0.98; each a singlet), one acetoxymethyl (δ 1.98, s), two oxygen-bearing methines (δ 5.38, brs; H-6 and δ 4.24, brs; H-7), and two oxymethylene protons (δ 4.79, dd, J) 17.2, 2.0 Hz, H-11a and δ 4.71, d, J) 17.2 Hz, H-11b). The ¹³C NMR spectrum showed 17 resonances, including one lactone and one O-acetyl carbonyl (δ 169.9 and 170.0, respectively), and two quaternary sp² carbons, one of which was deshielded (δ 173.6 ppm). All of the above data were suggestive of the presence of a drimane sesquiterpene lactone.^{2,3} Interpretation of the COSY spectrum led to the proposal of two partial structures: —CH₂—CH₂—CH₂— and —CH—CHOCHO—. The full structure of 1 was determined by careful analysis of the HSQC and HMBC spectra. Long-range correlations between H-6 and C-4 and between C-8 and C-10, on one hand, and between H-7 and C-5, C-9, and C-12 on the other hand allowed the oxygen bearing methines to be positioned at C-6 and C-7, and thus the hydroxymethylene must be located at C-11. The relative configurations of the hydroxy group at C-7 and the oxygen-bearing methine at C-6 were substantiated by the coupling observed in the ¹H NMR spectrum as a broad singlet due to the dihedral angles between H-5 and H-6 and between H-6 and H-7 (δ 5.38, brs; H-6 and δ 4.24, brs; H-7). hydroxy group at C-7 and the oxygen-bearing methine at C-6 were substantiated by the coupling observed in the ¹H NMR spectrum as a broad singlet due to the dihedral angles between H-5 and H-6 and between H-6 and H-7 (δ 5.38, brs; H-6 and δ 4.24, brs; H-7).

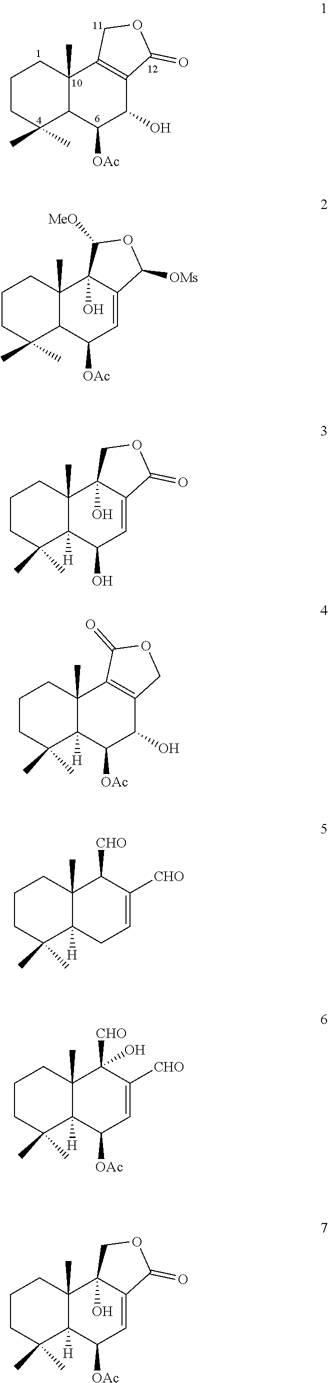

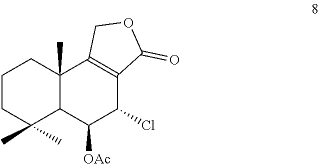

TABLE 2
¹H NMR Data for Compounds 1 and 2 (400 MHz, in CDCl₃)^{a}

| position | 1 | 2 |
|---|---|---|
| 5 | 1.65 (brs) | 1.62 (d, 4.3) |
| 6 | 5.38 (brs) | 5.59 (brt, 4.5) |
| 7 | 4.24 (brs) | 6.71 (d, 4.0) |
| 8 | | |
| 9 | | |
| 10 | | |
| 11a | 4.79 (dd, 17.2, 2) | 4.90 (s) |
| 11b | 4.71 (d, 17.2) | |
| 12 | | 5.10 (s) |
| 13 | 1.41 (s) | 1.18 (s) |
| 14 | 0.98^{b} (s) | 0.99 (s) |
| 15 | 0.99^{b} (s) | 0.90 (s) |
| CH₃CdO | 1.98 (s) | 1.99 (s) |
| OCH₃-11 | | 3.52 (s) |
| OCH₃-12 | | 3.33 (s) |

^{a}Assignment based on HSQC, COSY, and HMBC spectroscopic data.
^{b}Assignments can be interchanged.

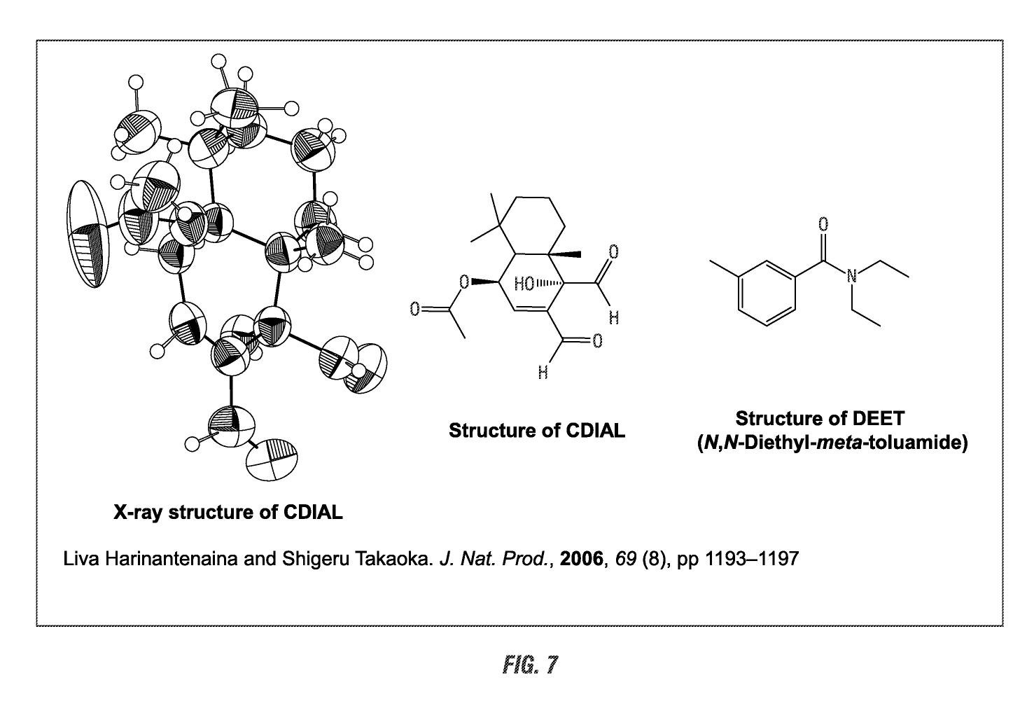

### FIG. 7. ORTEP Drawing and Chemical Structure of CDIAL.

chloride and pyridine, as described in the previous literature.⁹ The ¹H NMR data of 8 were very similar to those of 1, indicating that 8 is a chloro derivative of 1. The absolute stereostructure of 8 was confirmed by X-ray crystallography. The negative sign of the optical rotation of both 1 and 8 indicated that they have the same absolute configuration. From the above data, the structure of cinnamadin (1) was deduced.

Cinnamodial 11R,12-dimethyl acetal (2) exhibited a molecular formula of C₁₉H₃₀O₆, as designated by the positive HRESIMS (m/z 377.1934 [M+Na]⁺). The IR band at νₘₐₓ 1725 cm⁻¹ suggested the presence of an acetyl carbonyl group. The ¹H NMR spectrum showed three quaternary methyl proton resonances (δ 1.18, 0.99, and 0.90; each a singlet), two acetal proton signals (δ 5.10, H-12 and δ 4.90, H-11; both singlets), an acetoxyl methyl signal at δ 1.99, two methoxy groups (δ 3.52 and 3.33; both singlets), an oxygen-bearing methine (δ 5.59, brt, J) 4.5 Hz; H-6), and an olefinic methine at δ 6.71 (d, J) 4.0 Hz; H-7). The ¹³C NMR data displayed 19 resonances that were very similar to those of 7-drimene-11R,12-dimethyl acetal, previously isolated from Canella winterana (Canellaceae).¹⁰ The allocations of the acetyl group at C-6, the two methoxyl groups at C-11 and C-12, and the C-11 and C-12 acetals were supported by careful interpretation of the HSQC, HMBC, and NOESY spectroscopic data. The long-range correlations observed between H-11 and C-8 and C-10, between H-12 and C-7 and C-9, and between the methoxyl protons at δ 3.52 and 3.33 and C-11 and C-12, respectively, substantiated the locations of the acetal groups at C-11 and C-12, where the methoxy groups are attached. The relative configurations of the C-11 and C-12 methoxy groups were deduced as follows. The cross-peaks observed between the H-11 and H-13 methyl protons, between H-11 and the C-12 methoxyl protons, and between H-5 and the C-11 methoxyl protons observed in the NOESY spectrum provided evidence for the configuration of C-11 and C-12 as depicted for 2. Furthermore, the -orientation of the C-6 acetyl group was deduced by the NOE cross-peak between H-6 and H-5. Therefore the structure of 2 was concluded to be cinnamodial 11R,12-dimethyl acetal.

Alpha-glucosidase (EC 3.2.1.20) is a well-known enzyme catalyzing the final step in the digestive process of carbohydrates. Its inhibitors can be thus very useful for the control of postprandial hyperglycemia, which a main cause of diabetes and obesity.³ In a continuation of our systematic screening of Alpha-glucosidase inhibitory activity of Cinnamosma metabolites, compounds 1-7 isolated from C. madagascariensis, together with compound 8, were evaluated (Table 3). Apart from cinnamodial (6), which was reported to have a strong inhibition,³ ugadensolide (4) showed moderate activity (46.2%). The alpha-glucosidase inhibitory properties of compounds 1-8 can be summarized as follows: (1) Substitution of the hydroxy group at C-7 of 1 by chlorine increases the activity by 2-fold. (2) The presence of a hydroxy group at a-position to the lactone carbonyl decreases the activity. Unexpectedly, polygodial (5), which has a similar structure to 6, showed only slight activity. As stated in a previous paper,² the presence of a C-9 aldehyde group in drimanetype sesquiterpenes and a C-12′ hydroxyl in the cinnafragrins are necessary for Alpha-glucosidase inhibition. (3) Since polygodial (5) and isopolygodial² did not show any activity, the -orientation of the C-9 aldehyde and the presence of both a C-9 hydroxy and a C-6 acetoxy groups seem to be very important for potent Alpha-glucosidase inhibition within this class of compounds.

Cinnamosma is one of the five genera of the Canellaceae family. Thirty-one compounds have been isolated from three species of the genus Cinnamosma ( ).^{2-5,9,11,12} Their pungent taste is mainly due to the presence of cinnamodial (6), although polygodial is also isolated from C. madagascariensis. C. fragrans displayed the highest amounts of 6. Hence, this species is the most pungent. The bitter taste of the present sample of C. madagascariensis is due to its high content of 7 (5%). C. madagascariensis has been reported to contain chakranine,⁴ N_{b}p-coumaroyl- and N_{b}-feruloyltryptamine, (+)-lyoniresinol, and

TABLE 3
¹³C NMR Data for Compounds 1 and 2 (100 MHz, in CDCl₃)

| position | 1 | 2 |
|---|---|---|
| 1 | 38.4 | 31.9 |
| 2 | 18.5 | 19.6 |
| 3 | 42.8 | 44.5 |
| 4 | 33.5 | 33.6 |
| 5 | 48.5 | 44.9 |
| 6 | 72.3 | 67.3 |
| | 63.6 | 134.9 |
| 8 | 122.7 | 131.5 |
| 9 | 173.6 | 76.7 |
| 10 | 37.2 | 38.9 |
| 11 | 68.5 | 104.3 |
| 12 | 169.9 | 104.1 |
| 13 | 22.5 | 32.9 |
| 14 | 23.1 | 24.2 |
| 15 | 33.0 | 18.0 |
| CH₃ C═O | 21.3 | 21.3 |
| CH₃ C═O | 170.0 | 170.1 |
| OCH₃ | | 56.6 |
| OCH₃ | | 54.9 |

TABLE 4
alpha-Glucosidase Inhibition Activities of Compounds
1-8^{a} compound alphaAlpha-glucosidase inhibition (%)

| | |
|---|---|
| 1 | 14.9 |
| 2 | not active |
| 3 | 7.2 |
| 4 | 46.2 |
| 5 | 2.1 |
| 6 | 83.7 |
| 7 | 20.0 |
| 8 | 28.1 |
| 1-deoxynojirimycin^{b} | 100 |

^{a}At 0.1 mg/mL (final concentration).
^{b}Used as positive control.

5-methoxy-9-xylopyranosyl-(−)-isolariciresinol.⁵ During the present investigation, no alkaloids were detected in C. madagascariensis by spraying a developed TLC plate of the crude plant extract with Dragendorff reagent. Except for capsicodendrin, no dimeric compounds were present in C. madagascariensis. Polygodial (5) was isolated from C. madagascariensis, while isopolygodial has been detected only from C. macrocarpa. The present results represent the first detection of pungent unsaturated dialdehyde compound 5 apart from cinnamodial (6) in Cinnamosma species. The three species of Cinnamosma contain quite similar amounts of S-tocotrienol. Lignoceric acid was isolated from Cinnamosma species for the first time.

### Experimental Section

General Experimental Procedures. Optical rotations were measured on a JASCO P-1030 digital polarimeter. FT-IR spectra were recorded on a Horiba FT-710 spectrophotometer. UV spectra were measured with a JASCO V-520 UV/vis spectrometer. ¹H and ¹³C NMR spectra were recorded on a JEOL R-400 spectrometer (400 and 100 MHz, respectively) with TMS as internal standard. HRESIMS were carried out on an Applied Biosystems QSTAR XL system mass spectrometer. Silica gel, Sephadex, column chromatography, and reversed-phase [octadecyl silica (ODS) gel] open column chromatography were performed on silica gel 60 (Merck, 70-230 mesh), Sephadex LH-20 (GE Healthcare Bio-Sciences AB, Upsala, Sweden), and Cosmosil 75C18-OPN (Nacalai Tesque Co., Ltd., Kyoto, Japan). Preparative HPLC was performed using ODS-120T (TSK gel, B) 10 mm, L) 28 cm; Tosoh, Tokyo, Japan).

Plant Material.

The bark of C. madagascariensis was collected in Sakaraha, near Tulear, Madagascar, in December 2006 by one of the authors (L.H.) and was identified by comparison with an authentic sample in the Herbarium of PBZT (Parc Botanique et Zoologique de Tsimbazaza, Antananarivo Madagascar). A voucher specimen (LivCINMAD2006) was deposited at the Graduate School Biomedical Sciences, Department of Pharmacognosy, Hiroshima University, Japan.

Extraction and Isolation.

Powdered C. madagascariensis bark (292 g) was extracted with EtOAc (2 L) at room temperature for a week. The extract was filtered and concentrated in vacuo to yield a dark brown residue (23 g). The residue was dissolved in MeOH to obtain 3 g of white precipitate (D-mannitol). The remaining solution was evaporated and suspended in water before partition with ethyl acetate to afford 15.2 g of residue. White crystals (cinnamosmolide: 11, 11.3 g) were obtained by dissolving the ethyl acetate fraction in hexane-ethyl acetate (7:3). The remaining solution was divided into three fractions by size exclusion column chromatography on Sephadex LH-20 (solvent system: methanol-CH₂Cl₂, 9:1). ODS flash column chromatography of fraction 2 gave eight subfractions. Compounds 7 (1.5 mg), 11 (2.3 mg), and 4 (3 mg) were obtained from preparative TLC (solvent system: hexane-ethyl acetate, 4:1) of subfraction 2-1. Silica gel column chromatography of subfraction 2-7 (solvent system: hexane-ethyl acetate, 4:1) afforded compound 12 (17 mg). ODS HPLC (solvent system: 60% aqueous CH₃CN) of subfractions 2-2 and 2-3 afforded compounds 4 (32 mg), 11 (13 mg), 7 (19 mg), 8 (25 mg), 9 (3 mg), and 2 (4.2 mg). Lignoceric acid (10, 23 mg) was precipitated from subfraction 2-4. The mother liquor of the latter was subjected to ODS HPLC (solvent system: 90% aqueous MeOH) to give compound 5 (75 mg). Capsicodendrin (6, 40 mg) was crystallized from fraction 2-5. Purification of subfraction 2-7 by ODS HPLC (solvent system: 50% aqueous CH₃CN) yielded compounds 1 (5.4 mg) and 3 (3.5 mg).

Cinnamadin (1): amorphous powder, [R] −15.2 (c 0.2, CHCl₃); IR νₘₐₓ 3420, 2925, 2854, 1730, 1675, 1508, 1239, 1026 cm⁻¹; UV (MeOH) λₘₐₓ(log ∈) 225 (4.22) nm; ¹H NMR and ¹³C NMR spectra (see Tables 2 and 3); positive HRESIMS m/z 331.1511 [M+Na]⁺ (C₁₇H₂₄O₅Na, requires 331.1521).

Cinnamodial 11r,12-dimethyl acetal (2): amorphous powder, [R] −99.2 (c 0.28, MeOH); IR νₘₐₓ 1725, 1508, 1019 cm⁻¹; ¹H NMR and ¹³C NMR spectra (see Tables 2 and 3); positive HRESIMS m/z 377.1934 [M+Na]⁺ (C₁₉H₃₀O₆Na, requires m/z 377.1940). X-ray Crystallographic Analysis of 8. The chloro derivative (8, 110 mg) of cinnamosmolide (7, 180 mg) was prepared following a literature procedure.⁹ Crystal data: Colorless crystal; C₁₇H₂₃ClO₄, Mᵣ) 326.80, orthorhombic, P2₁2₁2₁, a) 7.9937(15) Å, b) 13.664(3) Å, c) 15.543(3) Å, V) 1697.7(6) Å³, Mo KR radiation, Å) 0.71073,

10 353 reflections, 203 parameters; only coordinates of H atoms refined. Final R indices [I>2σ(I)] R₁) 0.0505, wR₂) 0.1119, R indices (all data) R₁) 0.0868, wR₂) 0.1259. The atomic ordinates and equivalent isotropic deplacement parameters, as well as a full list of bond distances and angles and the structure factor table, are deposited as Supporting Information at the Cambridge Crystallographic Data Centre (deposition number: CCDC 659441). Copies of the data can be obtained, free of charge, on application to the Director, CCDC, 12 Union Road, Cambridge CB2 IEZ, UK (fax: +44-(0) 1223-336033 or e-mail: deposit@ccdc.cam.ac.uk).

Alpha-Glucosidase Inhibition Assay.

The assay was performed according to the 126 Journal of Natural Products, 2008. Vol. 71. No. 1 Notes

method described by Oki and co-workers, with slight modifications.¹³ alpha-Glucosidase was purchased from Toyobo Co., Ltd. (Osaka. Japan). The enzyme solution was prepared by dissolving 0.6 U/mL of Alpha-glucosidase in 100 mM phosphate buffer (pH 7) containing 2 g/L bovine serum albumin and 0.2 g/L NaN₃. p-Nitrophenyl-R-D-glucopyranoside (5 mM) in the same buffer solution (pH 7) was used as a substrate solution. The enzyme solution (50 μL) and the test compounds (10 μL), dissolved in DMSO to a final concentration of 0.1 mg/mL, were mixed in each well of the microliter 96-well culture plates and measured spectrophotometrically (absorbance 405 nm) at zero time, using a microplate reader (Bio-Rad model 550 microplate reader). The mixture was preincubated for 5 min at room temperature before the addition of substrate solution (50 μM) and followed by a 5 min incubation at room temperature. The increase in absorbance from zero time was measured. The inhibitory activity was expressed as 10 minus the relative absorbance difference (%) of test compounds to absorbance change of the control where the test solution was replaced by DMSO. Experiments were performed in triplicate, and the averages were calculated and are presented in Table 4. 1-Deoxynojirimycin (Wako Pure Chemical Industries, Ltd.) 0.3 mM in DMSO was used as a positive control.

### References and Notes

(1) Pemet, R.; Meyer, G. Pharmacopée de Madagascar; Publication de l'institut de Recherche Scientifique: Tananarive-Tsimbazaza, 1957; pp 1-86.
(2) Harinantenaina, L.; Takaoka, S. J. Nat. Prod. 2006, 69, 1193-1197.
(3) Harinantenaina, L.; Asakawa, Y.; Declerq, E. J. Nat. Prod. 2007, 70, 277-282.
(4) Canonica, L.; Corbella, A.; Gariboldi, P.; Jommi, G.; Krepinski, J. Tetrahedron 1969, 25, 3903-3908.
(5) Vecchietti, V.; Ferrari, G.; Orsini, F.; Pelizzoni, F. Phytochemistry 1979, 18, 1847-1849.
(6) Kida, T.; Shibai, H.; Seto. H. J. Antibiot. 1986, 29, 613-615.
(7) Mahmoud, I. I.; Kinghom, A. D.; Cordell, G. A.; Farnsworth, N. R. J. Nat. Prod. 1980, 43, 365-371.
(8) Fukuyama, Y.; Sato, T.; Miura, I.; Asakawa, Y. Phytochemistry 1985, 24, 1521-1524.
(9) Canonica, L.; Corbella, A.; Gariboldi, P.; Jommi, G.; Krepinski, J.; Ferrari, G.; Casagrande, C. Tetrahedron 1969, 25, 3895-3902.
(10) Ying, B.-P.; Peiser, G.; Ji, Y.-Y.; Mathias, K.; Tutko, D.; Hwang, Y.-S. Phytochemistry 1995, 38, 909-915.
(11) Canonica, L.; Corbella, A.; Jommi, G.; Krepinski, J.; Ferrari, G.; Casagrande, C. Tetrahedron Lett. 1967, 23, 2137-2141.
(12) Bastos, K. J.; Kaplan, M. A. C.; Gottlieb, O. R. J. Braz. Chem. Soc. 1999, 10, 136-139.
(13) Oki, T.; Matsui, T.; Osajima, Y. J. Agric. Food Chem. 1999, 47, 550-553.

### Example 4

### Evidence for OSU-1 as a Potential Mosquito Repellent:

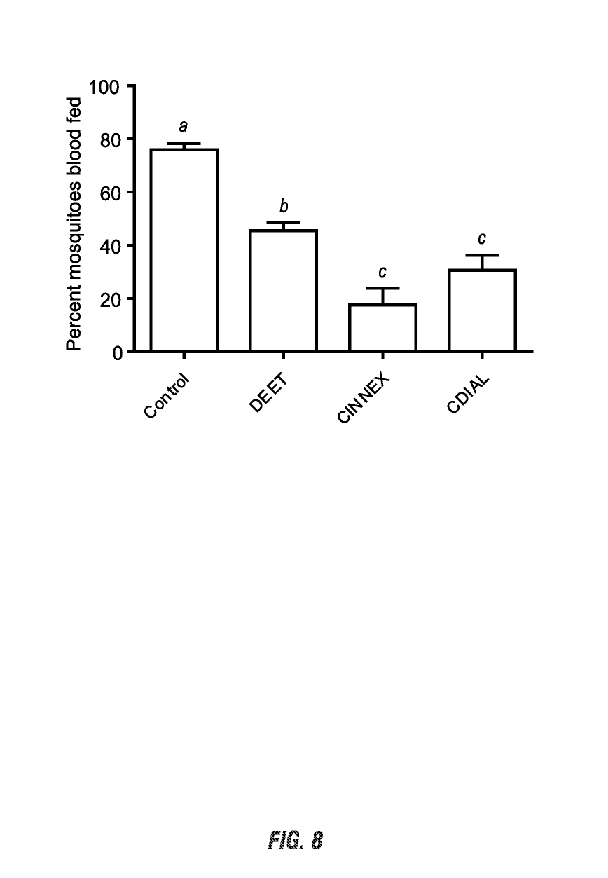

We used a blood-feeding bioassay to test the efficacy of OSU-1 (CDIAL) and the C. fragrans bark extract (CINEX) to repel mosquitoes from feeding on a blood source. In brief, cages of 20 mosquitoes (adult female Aedes aegpti) were starved for 24 h before being allowed to feed on a membrane feeder (Hemotek) containing defibrinated rabbit blood. After 1 h, the mosquitoes were immobilized on ice and the number of individuals with blood in their abdomen was counted. The membrane feeder maintains the blood at a constant temperature of 37° C. (human body temperature) and is covered with a collagen membrane that mimics human skin. Mosquitoes pierce through the collagen membrane with their proboscis to obtain the blood. To make the blood source attractive to mosquitoes, 10% lactic acid (a known mosquito attractant) is applied to the collagen membrane with a cotton wick and 0.01 g/ml of adenosine triphosphate (a feeding stimulant) is added to the blood. The blood feeding experiments took place in a rearing chamber held at 28° C. (80% relative humidity), and occurred around the same time each day (˜1-3 PM). Both OSU-1 and CINEX significantly reduced the percentage of mosquitoes feeding on a blood source when they were applied to a nylon fabric covering the blood source (20.8 μg/cm²) (FIG. 8). Moreover, these compounds were significantly more effective than DEET (20.8 μg/cm) at reducing the percentage of mosquitoes that fed on blood (FIG. 8); DEET is the gold standard for a mosquito repellent. Values in FIG. 8 are means±SEM; N=31, 9, 5, and 15 respectively for Control, DEET, CINEX, and CDIAL. Lower-case letters indicate statistical categorization of the means as determined by a one-way ANOVA with a Newman-Keuls posttest (P<0.05).

What is claimed is:

1. An insecticidal/repellant composition comprising:
a plant, or an extract of said plant, containing an insecticidal sesquiterpene component, wherein said plant is from the species Cinnamosama fagrans, Cinnamosama macrocarpa and Cinnamosama madagascariensis and a carrier.

2. The insecticidal/repellant composition according to claim 1, wherein said insecticidal component includes one or more of: cinnamodial, cinnafragrin A, and/or cinnamosmolide or an insecticidally optimized derivative thereof.

3. The insecticidal/repellant composition of claim 2 wherein said insecticidal component has on of the following chemical formulas:

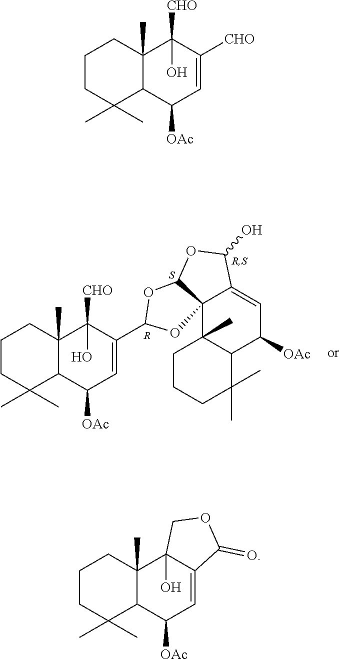

4. The insecticidal/repellant composition of claim 2 wherein said sesquiterpene has one or more of the following formulas:

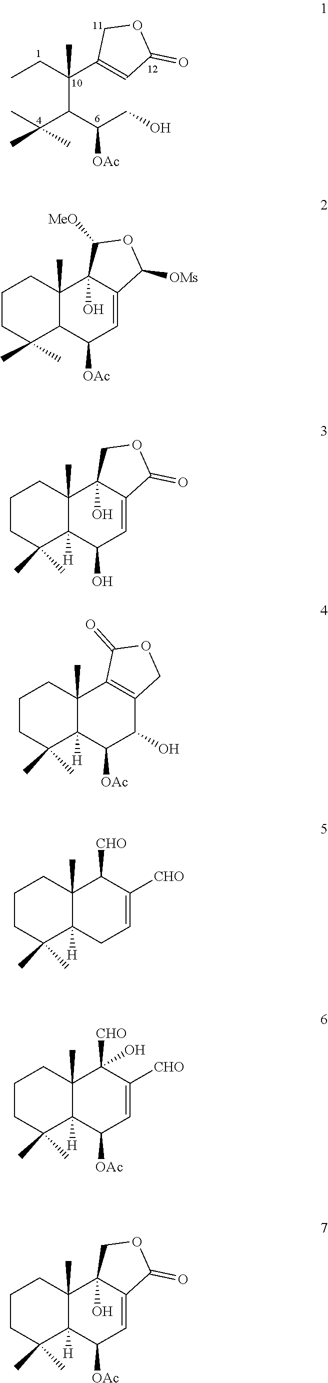

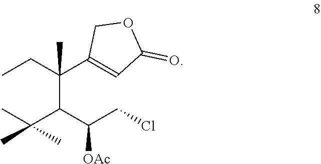

5. The insecticidal/repellant composition of claim 1, wherein said extract is a substance extracted with at least one member selected from the group consisting of water and a hydrophilic solvent.

6. The insecticidal/repellant composition of claim 1, wherein the amount of said insecticidal component is 0.01 to 80% by weight relative to the insecticide in terms of the carrier.

7. The insecticidal/repellant composition of claim 1, wherein said insecticide is in the form of a liquid preparation, a solid preparation, a semi-solid preparation, a spray, an aerosol, or a coating composition.

8. The insecticidal/repellant composition of claim 1, wherein said insecticide is effective against Aedes aegypti, Culex pipiens, Aphis glycines or malaria causing mosquitoes (Anopheles gambiae).

9. The insecticidal/repellant composition of claim 1 wherein said insecticide is capable of preventing insect borne diseases of malaria, dengue fever, chikungunya fever, Zika fever, West Nile fever, yellow fever or soybean aphid infestation.

10. The insecticidal/repellant composition of claim 1, wherein said insecticide is applicable to an insect selected from the group consisting of a mosquito, or an aphid.

11. A method for producing an insecticide/repellant which comprises subjecting a plant recited in claim 1 to at least one step selected from the group consisting of: (i) a treatment step comprising at least one step selected from the group consisting of shredding, drying and pulverizing; (ii) an extraction step using an extracting solvent; whereby obtaining at least one member selected from the group consisting of a treated plant, an extract of the plant, each containing an insecticidal component.

12. The method of claim 12, wherein the extracting solvent is at least one member selected from the group consisting of water, an alcohol, an ether, a ketone, an ester, a halogenated hydrocarbon, an aliphatic hydrocarbon, an alicyclic hydrocarbon, an aromatic hydrocarbon, a nitrile, a carboxylic acid, and an aprotic polar solvent.

13. The method of claim 12, wherein the extracting solvent is at least one member selected from the group consisting of water and a hydrophilic solvent.

14. The method for repelling or exterminating an insect by using an insecticide recited in claim 1.

15. A method according to claim 15, wherein said insecticide is applied to an insect, or an invasion or infestation spot.

16. A method according to claim 15, wherein said insecticide is applied to the spot by coating, distributing, dipping, impregnating, injecting, mixing, or atomizing.

17. The method of claim 14 wherein said composition includes one or more of: cinnamodial, cinnafragrin A, and/or cinnamosmolide or an insecticidally optimized derivative thereof.

18. The method of claim 17 wherein said insecticidal component has one of the following chemical formulas:

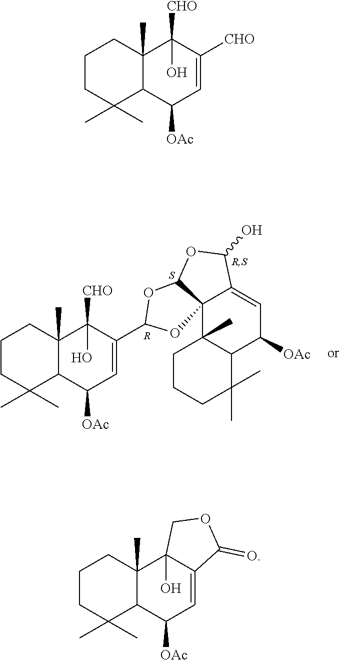

19. The method of claim 18 wherein said sesquiterpene has one or more of the following formulas:

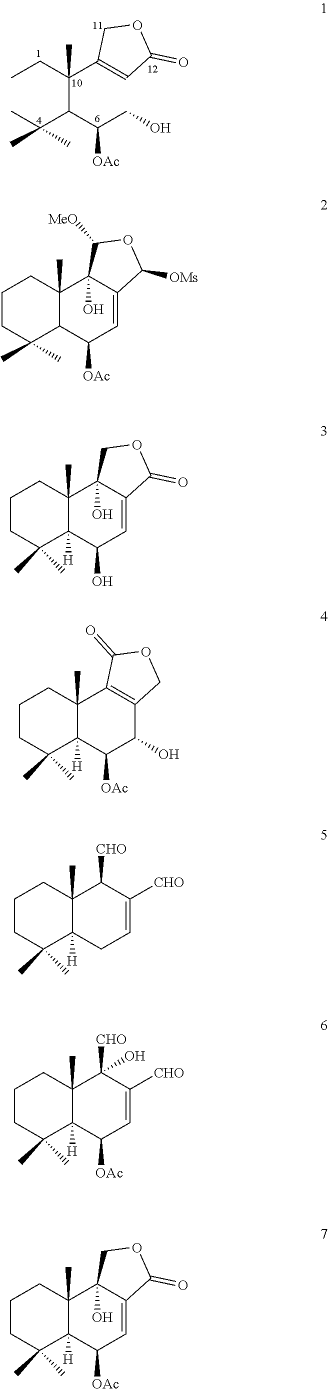

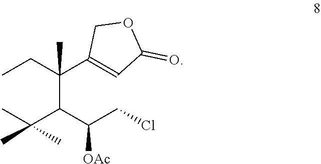

20. The method of claim 14 wherein said sesquiterpene is isolated from C. madagascariensis.
